(19) United States
(12) Patent Application Publication
(10) Pub. No.: US 2018/0069969 A1
(43) Pub. Date: Mar. 8, 2018

(54) IMAGE FORMING APPARATUS AND IMAGE FORMING SYSTEM

(71) Applicant: FUJI XEROX CO., LTD., Tokyo (JP)

(72) Inventors: Masahiko HARADA, Kanagawa (JP); Akihiro ISHII, Kanagawa (JP); Masahide HARADA, Kanagawa (JP)

(73) Assignee: FUJI XEROX CO., LTD., Tokyo (JP)

(21) Appl. No.: 15/607,943

(22) Filed: May 30, 2017

(30) Foreign Application Priority Data
Sep. 2, 2016 (JP) 2016-172251

(51) Int. Cl. H04N 1/00; G06F 3/01; G06F 15/167

(52) U.S. Cl. CPC H04N 1/00206; H04N 1/00973; H04N 1/00954; H04N 1/00302; G06F 3/012; G06F 15/167; G06F 15/163; H04N 2201/001; H04N 1/00962; H04N 1/00912; H04N 1/00832; G06F 3/011; H04N 1/00204

(57) ABSTRACT

An image forming apparatus forms a virtual image forming apparatus including plural mutually communicably connected image forming apparatuses including at least one functional image forming apparatus having a storage function of storing an image formation request including image information and serving as a master and at least one image forming apparatus serving as a slave. The image forming apparatus includes a transmitting unit and a receiving unit. The transmitting unit transmits master information and first identification information to the at least one image forming apparatus serving as the slave. The master information indicates that the at least one functional image forming apparatus is the master. The first identification information identifies the master. The receiving unit receives second identification information that identifies the at least one image forming apparatus serving as the slave.

### CROSS-REFERENCE TO RELATED APPLICATIONS

This application is based on and claims priority under 35 USC 119 from Japanese Patent Application No. 2016-172251 filed Sep. 2, 2016.

### BACKGROUND

The present invention relates to an image forming apparatus and an image forming system.

### SUMMARY

According to an aspect of the invention, there is provided an image forming apparatus that forms a virtual image forming apparatus including plural mutually communicably connected image forming apparatuses including at least one functional image forming apparatus having a storage function of storing an image formation request including image information and serving as a master and at least one image forming apparatus serving as a slave. The image forming apparatus includes a transmitting unit and a receiving unit. The transmitting unit transmits master information and first identification information to the at least one image forming apparatus serving as the slave. The master information indicates that the at least one functional image forming apparatus is the master. The first identification information identifies the master. The receiving unit receives second identification information that identifies the at least one image forming apparatus serving as the slave.

### BRIEF DESCRIPTION OF THE DRAWINGS

An exemplary embodiment of the present invention will be described in detail based on the following figures, wherein:

FIG. 1 is a block diagram illustrating a schematic configuration of an image forming system according to the present exemplary embodiment;

FIG. 2 is a block diagram illustrating a schematic configuration of an image forming apparatus included in the image forming system according to the present exemplary embodiment;

FIG. 3 is a block diagram illustrating a schematic configuration of an information processing apparatus included in the image forming system according to the present exemplary embodiment;

FIG. 4A is a diagram illustrating an example of a system menu screen;

FIG. 4B is a diagram illustrating an example of a virtual image forming apparatus name selection screen;

FIG. 4C is a diagram illustrating an example of a confirmation screen;

FIG. 4D is a diagram illustrating an example of the system menu screen;

FIG. 4E is a diagram illustrating an example of the virtual image forming apparatus name selection screen;

FIG. 5 is a flowchart illustrating an example of a process performed by an image forming apparatus selected as a master in the formation of a virtual image forming apparatus of the image forming system according to the present exemplary embodiment;

FIG. 6 is a flowchart illustrating an example of a process performed by the image forming apparatus after master declaration in the image forming system according to the present exemplary embodiment;

FIG. 7 is a flowchart illustrating an example of a process performed by an image forming apparatus that is to be registered as a slave in the formation of the virtual image forming apparatus of the image forming system according to the present exemplary embodiment;

FIG. 8 is a diagram for illustrating an example of a method of registering the master and the slave of the virtual image forming apparatus and image formation by the virtual image forming apparatus; and

FIG. 9 is a diagram illustrating another example of the method of registering the master and the slave of the virtual image forming apparatus.

### DETAILED DESCRIPTION

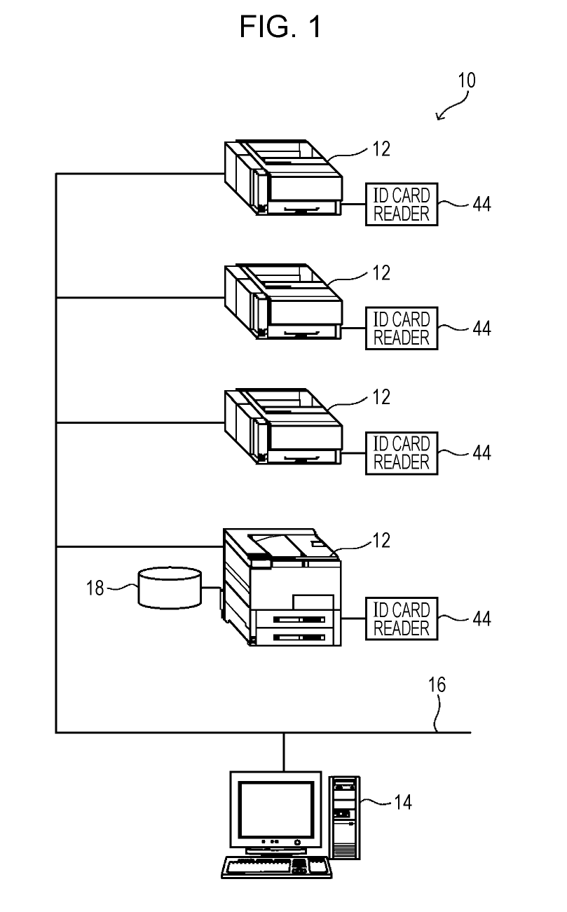

An example of the present exemplary embodiment will be described in detail below with reference to the drawings. FIG. 1 is a block diagram illustrating a schematic configuration of an image forming system according to the present exemplary embodiment.

As illustrated in FIG. 1, an image forming system 10 according to the present exemplary embodiment includes plural image forming apparatuses 12.

The plural image forming apparatuses 12 are connected to a network 16, such as a local area network (LAN), to be communicable with one another. At least one of the plural image forming apparatuses 12 has a function of storing an image formation request including image information in a storage unit 18, such as a hard disk or a flash memory. Further, each of the image forming apparatuses 12 is provided with an identification (ID) card reader 44 to read a card previously storing ID information to thereby identify a user. The network 16 may further be connected to an authenticating server for authenticating the user based on the ID information read by the ID card reader 44.

The network 16 is further connected to an information processing apparatus 14 that issues the image formation request. The information processing apparatus 14 issues the image formation request to each of the image forming apparatuses 12. Although FIG. 1 illustrates only one information processing apparatus 14, the network 16 is not necessarily connected to a single information processing apparatus 14, and may be connected to plural information processing apparatuses 14.

The image forming system 10 constructs a virtual image forming apparatus in which one of the plural image forming apparatuses 12 with the above-described storage function serves as a master and at least one of the other image forming apparatuses 12 serves as a slave. Further, the image formation request is issued from the information processing apparatus 14, for example, to the constructed virtual image forming apparatus to enable a given one of the image forming apparatuses 12 included in the virtual image forming apparatus to perform image formation. Specifically, the image formation request including the image formation is issued to the virtual image forming apparatus and stored in the storage unit 18 of the master image forming apparatus 12.

Then, the ID card reader 44 of a given slave image forming apparatus 12 in the virtual image forming apparatus identifies the user, and the slave image forming apparatus 12 receives the corresponding image formation request from the master image forming apparatus 12 and performs the image formation.

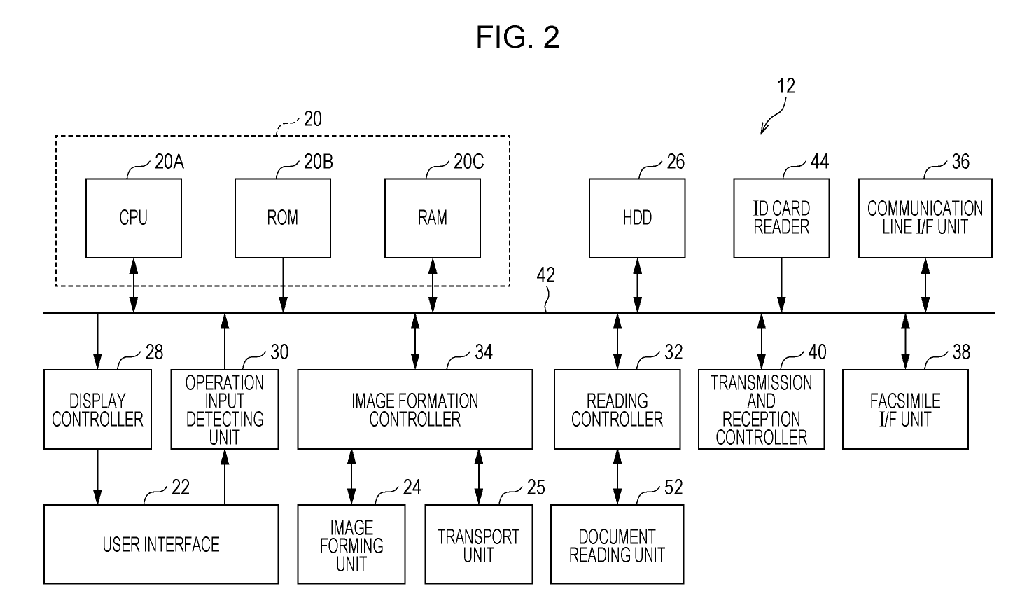

A configuration of each of the image forming apparatuses 12 in the image forming system 10 will now be described. FIG. 2 is a block diagram illustrating a schematic configuration of each of the image forming apparatuses 12 included in the image forming system 10 according to the present exemplary embodiment.

As illustrated in FIG. 2, the image forming apparatus 12 according to the present exemplary embodiment includes a control unit 20 including a central processing unit (CPU) 20A, a read only memory (ROM) 20B, and a random access memory (RAM) 200. The CPU 20A controls the operation of the entire image forming apparatus 12. The RAM 20C is used as, for example, a work area in the execution of various programs by the CPU 20A. The ROM 20B previously stores various control programs, various parameters, and so forth. Further, in the image forming apparatus 12, the respective units of the control unit 20 are electrically connected by a system bus 42.

The image forming apparatus 12 according to the present exemplary embodiment also includes a hard disk drive (HDD) 26 that stores various data, application programs, and so forth. Further, the image forming apparatus 12 is connected to a user interface 22, which is an example of a display, a selecting unit, an apparatus display, and an apparatus selecting unit. The image forming apparatus 12 further includes a display controller 28 that is connected to the user interface 22 to control display of, for example, various operation screens on the display included in the user interface 22. The image forming apparatus 12 further includes an operation input detecting unit 30 that is connected to the user interface 22 to detect an operation instruction input via the user interface 22. Further, in the image forming apparatus 12, the HDD 26, the display controller 28, and the operation input detecting unit 30 are electrically connected to the system bus 42. In the image forming apparatus 12 according to the present exemplary embodiment, the HDD 26 is applied as a memory. However, the memory is not limited thereto, and a non-volatile memory such as a flash memory may be applied. Further, in the image forming apparatus 12 serving as the master of the virtual image forming apparatus, the HDD 26 functions as the above-described storage unit 18.

The image forming apparatus 12 according to the present exemplary embodiment further includes a reading controller 32, an image formation controller 34, a communication line interface (I/F) unit 36, a facsimile interface (I/F) unit 38, and a transmission and reception controller 40. The reading controller 32 controls an optical image reading operation by document reading unit 52 and a document feeding operation by a document transport unit. The image formation controller 34 controls an image forming process by an image forming unit 24 and the transport of a recording sheet to the image forming unit 24 by a transport unit 25. The communication line I/F unit 36 is connected to the network 16 to transmit and receive communication data to and from another external apparatus connected to the network 16. The facsimile I/F unit 38 is connected to a not-illustrated telephone line to transmit and receive facsimile data to and from a facsimile apparatus connected to the telephone line. The transmission and reception controller 40 controls the transmission and reception of the facsimile data via the facsimile I/F unit 38. Further, in the image forming apparatus 12, the transmission and reception controller 40, the reading controller 32, the image formation controller 34, the communication line I/F unit 36, the facsimile I/F unit 38, and the above-described ID card reader 44 are electrically connected to the system bus 42.

With the above-described configuration, the CPU 20A of the image forming apparatus 12 according to the present exemplary embodiment executes access to the RAM 20C, the ROM 20B, and the HDD 26. Further, in the image forming apparatus 12, the CPU 20A executes control of display of the operation screens and information such as various messages on the display of the user interface 22 via the display controller 28. Further, in the image forming apparatus 12, the CPU 20A executes control of operations of the document reading unit 52 and the document transport unit via the reading controller 32. Further, in the image forming apparatus 12, the CPU 20A executes control of operations of the image forming unit 24 and the transport unit 25 via the image formation controller 34 and control of the transmission and reception of the communication data via the communication line I/F unit 36. Further, in the image forming apparatus 12, the CPU 20A executes control of the transmission and reception of the facsimile data via the facsimile I/F unit 38 by the transmission and reception controller 40. Further, in the image forming apparatus 12, the CPU 20A grasps the contents of the operation performed on the user interface 22 based on operation information detected by the operation input detecting unit 30, and executes various control based on these contents of the operation. The image forming apparatus 12 may employ a configuration in which at least one of the reading controller 32 and the document reading unit 52 and at least one of the transmission and reception controller 40 and the facsimile I/F 38 are omitted.

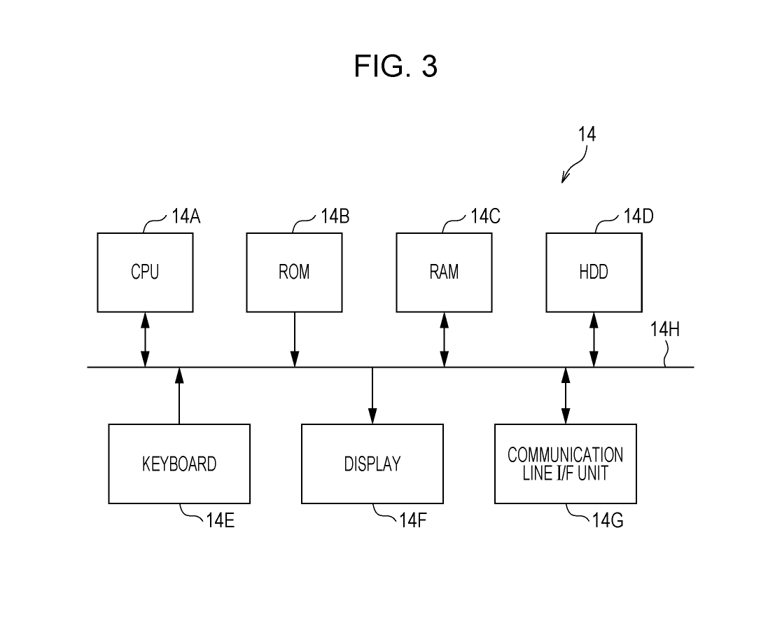

A schematic configuration of the information processing apparatus 14 will subsequently be described. FIG. 3 is a block diagram illustrating a schematic configuration of the information processing apparatus 14 included in the image forming system 10 according to the present exemplary embodiment.

As illustrated in FIG. 3, the information processing apparatus 14 includes a CPU 14A, a ROM 14B, a RAM 14C, an HDD 14D, a keyboard 14E, a display 14F, and a communication line interface (I/F) unit 14G. The CPU 14A controls the operation of the entire information processing apparatus 14. The RAM 14B previously stores various control programs, various parameters, and so forth. The RAM 14C is used as, for example, a work area in the execution of various programs by the CPU 14A. The HDD 14D stores various data, application programs, and so forth. The keyboard 14E is used to input various information. The display 14F is used to display various information. The communication line I/F unit 14G is connected to the network 16 to transmit and receive various data to and from another apparatus connected to the network 16. The above-described units of the information processing apparatus 14 are electrically connected to one another by a system bus 14H. In the information processing apparatus 14, the HDD 14D is applied as a memory. However, the memory is not limited thereto, and another non-volatile memory such as a flash memory may be applied.

With the above-described configuration, the CPU 14A of the information processing apparatus 14 according to the present exemplary embodiment executes access to the ROM 14B, the RAM 14C, and the HDD 14D, acquisition of various data via the keyboard 14E, and display of various information on the display 14F. Further, in the information processing apparatus 14, the CPU 14A executes control of the transmission and reception of the communication data via the communication line I/F unit 14G.

A description will be given herein of a method of constructing the above-described virtual image forming apparatus in the image forming system 10 according to the present exemplary embodiment.

A description will first be given of the setting of the image forming apparatus 12 that is to be the master in the construction of the virtual image forming apparatus.

In the present exemplary embodiment, the image forming apparatus 12 having the storage function of storing the image formation request including the image information is selected from the image forming apparatuses 12 on the network 16. The master of the virtual image forming apparatus is declared with the user interface 22 of the selected image forming apparatus 12 or with a predetermined management interface on the World Wide Web (Web). For example, if the user interface 22 of the image forming apparatus 12 is used, the user interface 22 displays previously prepared virtual image forming apparatus names (VPrint1 to VPrintN, for example) to prompt the user to select one therefrom, instead of inputting a given character string. In this process, the image forming apparatus 12 checks whether or not there is any virtual image forming apparatus already declared on the network 16 or whether or not the same virtual image forming apparatus name has been declared on the network 16 (for example, the image forming apparatus 12 checks whether or not there is any virtual image forming apparatus name declared on the network 16 in the past, or inquires of each of the image forming apparatuses 12 on the network 16 whether the image forming apparatus 12 uses the same virtual image forming apparatus name as the selected virtual image forming apparatus name). If there is an already declared virtual image forming apparatus name, the already declared virtual image forming apparatus name is displayed in an unselectable manner (subjected to a prohibition process, such as shading, for example).

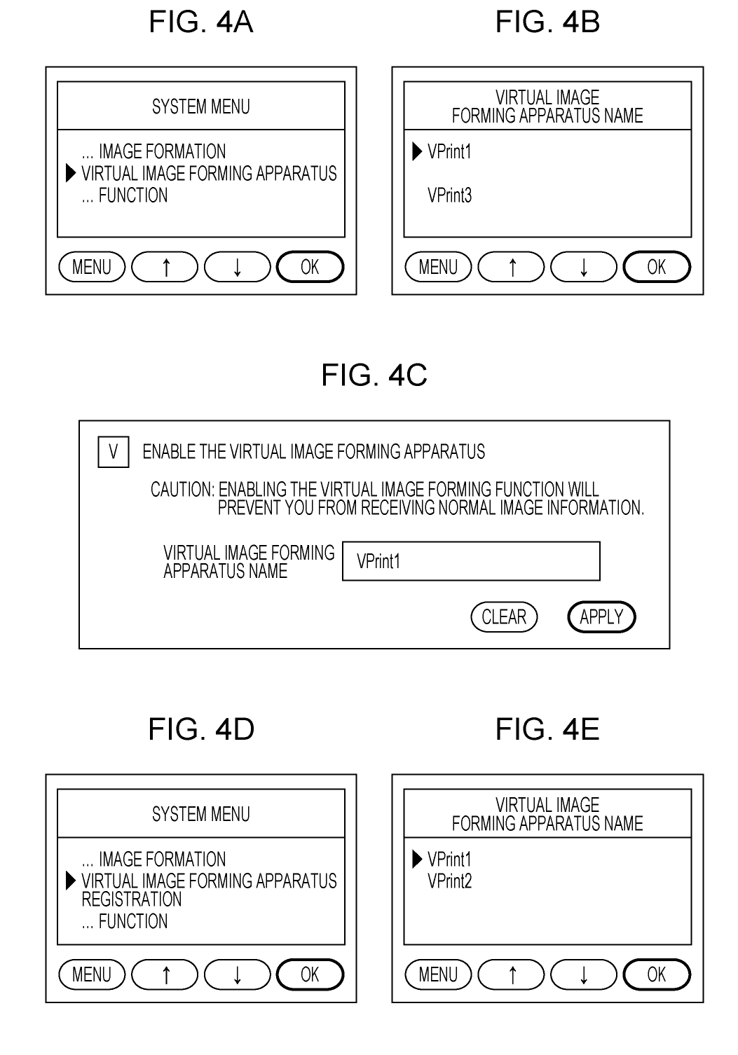

Specifically, a system menu screen illustrated in FIG. 4A is displayed on the user interface 22 of the image forming apparatus 12 that is to be declared as the master. FIG. 4A illustrates an example of the system menu screen displaying a menu of plural items (“. . . IMAGE FORMATION,” “VIRTUAL IMAGE FORMING APPARATUS,” and “. . . FUNCTION”). The user is prompted to select “VIRTUAL IMAGE FORMING APPARATUS” from the system menu by selecting items such as “⇓,” “⇑,” and “OK” in FIG. 4A through the operation of the user interface 22.

Then, in response to the selection of “VIRTUAL IMAGE FORMING APPARATUS” from the system menu, a virtual image forming apparatus name selection screen illustrated in FIG. 4B is displayed. FIG. 4B illustrates an example displaying previously prepared virtual image forming apparatus names (“VPrint1,” “VPrint2 (in use),” and “VPrint3”). The user is prompted to select a virtual image forming apparatus name from the virtual image forming apparatus name selection screen by performing an operation of selecting items such as “⇓,” “⇑,” and “OK” in FIG. 4B through the operation of the user interface 22. In FIG. 4B, “VPrint2,” which is declared, is subjected to the prohibition process.

In response to the selection of a virtual image forming apparatus name, a confirmation screen illustrated in FIG. 4C is displayed to prompt the user to confirm the selection. If “APPLY” in FIG. 4C is specified here through the operation of the user interface 22, declaration that the corresponding image forming apparatus 12 is the master of the virtual image forming apparatus is issued by broadcasting to the other image forming apparatuses 12 connected to the network 16. In this process, identification information, such as an Internet protocol (IP) address, of the master image forming apparatus 12 is transmitted to each of the image forming apparatuses 12 together with the virtual image forming apparatus name as master information indicating that the image forming apparatus 12 is the master. Thereby, name duplication is prevented, and later-described slave setting is performed. It is assumed that the broadcasting is performed periodically.

A description will now be given of the setting of the image forming apparatus 12 that is to be the slave in the construction of the virtual image forming apparatus.

One of the image forming apparatuses 12 on the network 16 is selected as the slave. Then, with the user interface 22 of the image forming apparatus 12 selected as the slave or with a predetermined management interface on the Web, the image forming apparatus 12 is set as the slave of the master image forming apparatus 12 declared as described above. The information of each declared virtual image forming apparatus has previously been transmitted by broadcasting to the image forming apparatuses 12 on the network 16. Therefore, if the user interface 22 of the image forming apparatus 12 is used, for example, this information is displayed on the user interface 22 to prompt the user to make a selection.

Specifically, a system menu screen illustrated in FIG. 4D is displayed on the user interface 22 of the image forming apparatus 12 that is to be the slave. FIG. 4D illustrates an example of the system menu screen displaying a menu of plural items (“. . . IMAGE FORMATION,” “VIRTUAL IMAGE FORMING APPARATUS REGISTRATION,” and “. . . FUNCTION”). The user is prompted to select “VIRTUAL IMAGE FORMING APPARATUS REGISTRATION” from the system menu by selecting items such as “⇓,” “⇑,” and “OK” in FIG. 4D through the operation of the user interface 22.

Then, in response to the selection of “VIRTUAL IMAGE FORMING APPARATUS REGISTRATION” from the system menu, a virtual image forming apparatus name selection screen illustrated in FIG. 4E is displayed. The virtual image forming apparatus name selection screen displays the virtual image forming apparatus name informed by the image forming apparatus 12 declared as the master. FIG. 4E illustrates an example displaying virtual image forming apparatus names (“VPrint1” and “VPrint2,” for example). The user is prompted to select a virtual image forming apparatus name from the virtual image forming apparatus name selection screen by selecting items such as “⇓,” “⇑,” and “OK” in FIG. 4E through the operation of the user interface 22.

In response to the selection of a virtual image forming apparatus name, slave registration to the master image forming apparatus 12 is performed with the identification information of the master image for apparatus 12 of the virtual image forming apparatus. If the slave registration is allowed through communication with the master image forming apparatus 12, a message indicating the completion of the registration is displayed. Specifically, a slave registration request is transmitted to the master image forming apparatus 12. Then, the master image forming apparatus 12 requests the slave image forming apparatus 12 to transmit information necessary for the slave registration. Thereby, attribute information and the identification information, such as the IP address, of the slave image forming apparatus 12 are transmitted to the master image forming apparatus 12 through the communication with the master image forming apparatus 12, and the virtual image forming apparatus is constructed. Examples of the attribute information include processable page description language (PDL) types and functions, processable sheet sizes, and the compatibility or incompatibility with color image formation.

To construct a virtual image forming apparatus, it has been necessary in the past to previously and individually set information such as the respective IP addresses of the master image forming apparatus 14 and the slave image forming apparatus 12 in all image forming apparatuses 12 that are to be set as the virtual image forming apparatus, thereby complicating the setting. According to the exemplary embodiment of the invention of the present application, on the other hand, the virtual image forming apparatus is constructed through the communication between the image forming apparatuses 12 even if the identification information such as the IP address is unknown. Therefore, the virtual image forming apparatus is constructed more easily than in a case in which information such as the identification information is manually set in the individual image forming apparatuses 12.

After the virtual image forming apparatus is thus formed, the user issues the image formation request to the virtual image forming apparatus from the information processing apparatus 14.

If the image forming apparatus 12 declared as the master has already been using an original image forming function thereof, that is, if the image forming apparatus is already installed with a driver, an option “use the image forming apparatus as the virtual image forming apparatus” in the properties of the driver is enabled. Then, the displayed virtual image forming apparatus name is selected. With this setting, the image formation request including the image information and issued with the driver is stored in the master image forming apparatus 12. This image formation request is authenticated by the ID card reader 44 connected to the slave image forming apparatus 12. Thereby, the slave image forming apparatus 12 executes image formation in accordance with the image formation request including the image information and stored in the master image forming apparatus 12.

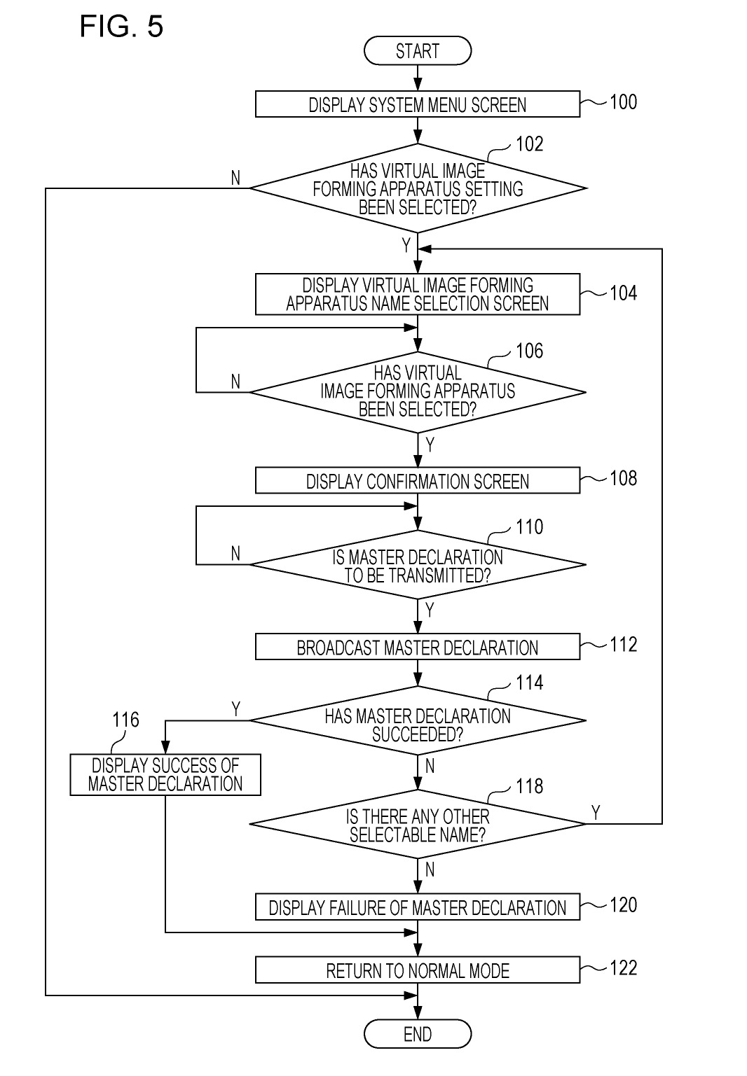

A description will subsequently be given of a specific process performed by the image forming apparatus 12 selected as the master in the construction of the virtual image forming apparatus of the image forming system 10 configured as described above. FIG. 5 is a flowchart illustrating an example of the process performed by the image forming apparatus 12 selected as the master in the construction of the virtual image forming apparatus of the image forming system 10 according to the present exemplary embodiment. The process of FIG. 5 starts when an instruction to display the system menu screen is issued through the operation of the user interface 22 of the image forming apparatus 12 selected as the master.

At step 100, the CPU 20A controls the display controller 28 to display the system menu screen on the user interface 22, and proceeds to step 102. Thereby, the above-described system menu screen illustrated in FIG. 4A, for example, is displayed on the user interface 22, and the CPU 20A shifts to a setting change mode. In the setting change mode, the image forming apparatus 12 may accept no new image formation request, or may accept an image formation request but execute no image forming process.

At step 102, the CPU 20A determines whether or not virtual image forming apparatus setting has been selected. In this determination, the CPU 20A determines whether or not the operation of selecting “VIRTUAL IMAGE FORMING APPARATUS” in FIG. 4A, for example, has been performed with the user interface 22. If the determination is positive, the CPU 20A proceeds to step 104. If the determination is negative with an item other than “VIRTUAL IMAGE FORMING APPARATUS” selected, the CPU 20A completes the present process to perform another process.

At step 104, the CPU 20A controls the display controller 28 to display the virtual image forming apparatus name selection screen on the user interface 22, and proceeds to step 106. Thereby, the virtual image forming apparatus name selection screen illustrated in FIG. 4B, for example, is displayed on the user interface 22.

At step 106, the CPU 20A determines whether or not a virtual image forming apparatus has been selected. That is, the CPU 20A determines whether or not the operation of selecting one of the virtual image forming apparatus names in FIG. 4B has been performed on the user interface 22. The CPU 20A stands by until the determination becomes positive, and then proceeds to step 108. If an operation for performing another process is performed during the standby, the CPU 20A may complete the present process to perform the another process.

At step 108, the CPU 20A controls the display controller 28 to display the confirmation screen on the user interface 22, and proceeds to step 110. Thereby, the confirmation screen illustrated in FIG. 4C, for example, is displayed on the user interface 22.

At step 110, the CPU 20A determines whether or not to transmit master declaration of the virtual image forming apparatus. In this determination, the CPU 20A determines whether or not the operation of specifying “APPLY” in FIG. 4C has been performed with the user interface 22. The CPU 20A stands by until the determination becomes positive, and then proceeds to step 112. If an operation for performing another process is performed during the standby, the CPU 20A may complete the present process to perform the another process.

At step 112, the CPU 20A transmits the master declaration by broadcasting to the other image forming apparatuses 12 connected to the network 16, and proceeds to step 114. For example,the CPU 20A transmits, as the master declaration, the master information indicating that the corresponding image forming apparatus 12 is the master and the identification information, such as the IP address, which identifies the master image forming apparatus 12. Step 112 corresponds to an example of a transmitting unit.

At step 114, the CPU 20A determines whether or not the master declaration has succeeded. In this determination, the CPU 20A checks if there is duplication of the virtual image forming apparatus name, for example. If there is no such duplication, the CPU 20A makes a positive determination and proceeds to step 116. Further, if there is duplication of the virtual image forming apparatus name, the CPU 20A makes a negative determination and proceeds to step 118.

At step 116, the CPU 20A controls the display controller 28 to display on the user interface 22 a message indicating that the master declaration has succeeded, and proceeds to step 122.

At step 118, on the other hand, the CPU 20A determines whether or not there is any other selectable name. If the determination is positive, the CPU 20A returns to step 104 to repeat the above-described processes. If the determination is negative, the CPU 20A proceeds to step 120.

At step 120, the CPU 20A controls the display controller 28 to display the failure of the master declaration on the user interface 22, and proceeds to step 122.

At step 122, the CPU 20A returns from the setting change mode to a normal mode, and completes the sequence of processes.

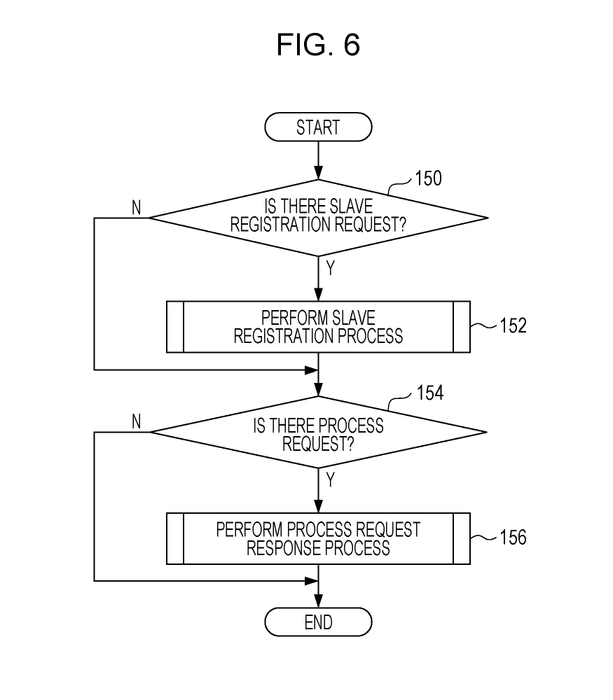

A description will subsequently be given of a process performed by the master image forming apparatus 12 after the master declaration. FIG. 6 is a flowchart illustrating an example of the process performed by the image forming apparatus 12 after the master declaration in the image forming system 10 according to the present exemplary embodiment.

At step 150, the CPU 20A determines whether or not there is a slave registration request. In this determination, the CPU 20A determines whether or not there is a slave registration request from the image forming apparatus 12 that is to be the slave. If the determination is positive, the CPU 20A proceeds to step 152. If the determination is negative, the CPU 20A proceeds to step 154.

At step 152, the CPU 20A performs a slave registration process, and proceeds to step 154. In the slave registration process, the CPU 20A receives slave information, which is transmitted as the slave registration request and includes the identification information, such as the IP address, of the image forming apparatus 12 that is to be the slave, for example. The CPU 20A registers the image forming apparatus 12 corresponding to the slave information as the slave. If there is no duplication of the slave information, the CPU 20A returns a message notifying the success of the registration to the image forming apparatus 12 corresponding to the slave information. Steps 150 and 152 correspond to an example of a receiving unit.

At step 154, the CPU 20A determines whether or not there is a process request from the image forming apparatus 12 registered as the slave. If the determination is positive, the CPU 20A proceeds to step 156. If the determination is negative, the CPU 20A completes the process to perform another process.

At step 156, the CPU 20A performs a process request response process, and completes the sequence of processes. In the process request response process, the CPU 20A receives the image formation request, which includes the image information and is transmitted from the information processing apparatus 14 as the process request, and temporarily stores the image formation request in the HUD 26. Then, if the user having issued the image formation request is identified by the ID card reader 44 of the slave image forming apparatus 12, and if the stored image formation request is specified, the CPU 20A performs a process of transmitting the stored image formation request including the image information to the slave image forming apparatus 12. Thereby, the slave image forming apparatus 12 performs image formation.

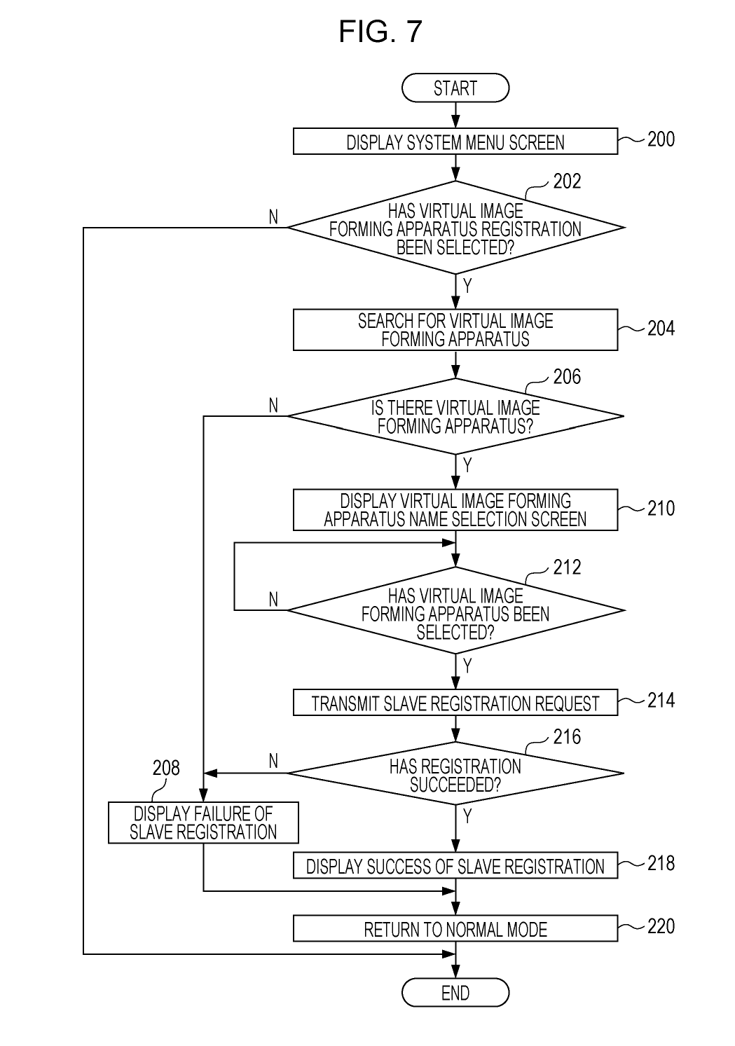

A description will now be given of a specific process performed by the image forming apparatus 12 that is to be registered as the slave in the construction of the virtual image forming apparatus of the image forming system 10 configured as described above. FIG. 7 is a flowchart illustrating an example of the process performed by the image forming apparatus 12 that is to be registered as the slave in the formation of the virtual image forming apparatus of the image forming system 10 according to the present exemplary embodiment. The process of FIG. 7 starts when an instruction to display the system menu screen is issued through the operation of the user interface 22 of the image forming apparatus 12 that is to be registered as the slave.

At step 200, the CPU 20A controls the display controller 28 to display the system menu screen on the user interface 22, and proceeds to step 202. Thereby, the above-described system menu screen illustrated in FIG. 4D, for example, is displayed on the user interface 22, and the CPU 20A shifts to the setting change mode.

At step 202, the CPU 20A determines whether or not the virtual image forming apparatus registration has been selected. In this determination, the CPU 20A determines whether or not the operation of selecting “VIRTUAL IMAGE FORMING APPARATUS REGISTRATION” in FIG. 4D, for example, has been performed with the user interface 22. If the determination is positive, the CPU 20A proceeds to step 204. If the determination is negative with another item other than “VIRTUAL IMAGE FORMING APPARATUS REGISTRATION” selected, the CPU 20A completes the present process to perform another process.

At step 204, the CPU 20A searches for a virtual image forming apparatus, and proceeds to step 206. The CPU 20A searches for the virtual image forming apparatus that has been notified by broadcasting by the image forming apparatus 12 declared as the master.

At step 206, the CPU 20A determines whether or not there is a virtual image forming apparatus. In this determination, the CPU 20A determines whether or not there is an image forming apparatus 12 declared as the master. If the determination is negative, the CPU 20A proceeds to step 208. If the determination is positive, the CPU 20A proceeds to step 210.

At step 208, the CPU 200 controls the display controller 28 to display a message notifying the failure of the slave registration on the user interface 22, and proceeds to step 220.

At step 210, on the other hand, the CPU 20A controls the display controller 28 to display the virtual image forming apparatus name selection screen on the user interface 22, and proceeds to step 212. Thereby, the virtual image forming apparatus name selection screen illustrated in FIG. 4E, for example, is displayed. FIG. 4E illustrates an example in which there are two virtual image forming apparatus names “VPrint1” and “VPrint2” each having a declared master.

At step 212, the CPU 20A determines whether or not a virtual image forming apparatus has been selected. That is, the CPU 20A determines whether or not the operation of selecting one of the virtual image forming apparatus names in FIG. 4E has been performed on the user interface 22. The CPU 20A stands by until the determination becomes positive, and then proceeds to step 214. If an operation for performing another process is performed during the standby, the CPU 20A may complete the present process to perform the another process.

At step 214, the CPU 20A transmits the slave registration request to the master image forming apparatus 12 of the selected virtual image forming apparatus, and proceeds to step 216. For example, the CPU 20A transmits, as the slave registration request, the slave information including the identification information, such as the IP address, of the image forming apparatus 12 that is to be the slave. Step 214 corresponds to an example of an information transmitting unit.

At step 216, the CPU 20A determines whether or not the slave registration has succeeded. In this determination, the CPU 20A determines whether or not the attribute information and the identification information, such as the IP address, of the slave image forming apparatus 12 have been transmitted to the master image forming apparatus 12 through the communication with the master image forming apparatus 12 in response to the slave registration request and the slave image forming apparatus 12 has been registered as the slave. If the determination is positive, the CPU 20A proceeds to step 218. If the determination is negative, the CPU 20A proceeds to step 208 described above.

At step 218, the CPU 20A controls the display controller 28 to display a message notifying the success of the slave registration on the user interface 22, and proceeds to step 220.

At step 220, the CPU 20A returns from the setting change mode to the normal mode, and completes the sequence of processes.

With each of the image forming apparatuses 12 thus performing the process, the virtual image forming apparatus is easily constructed.

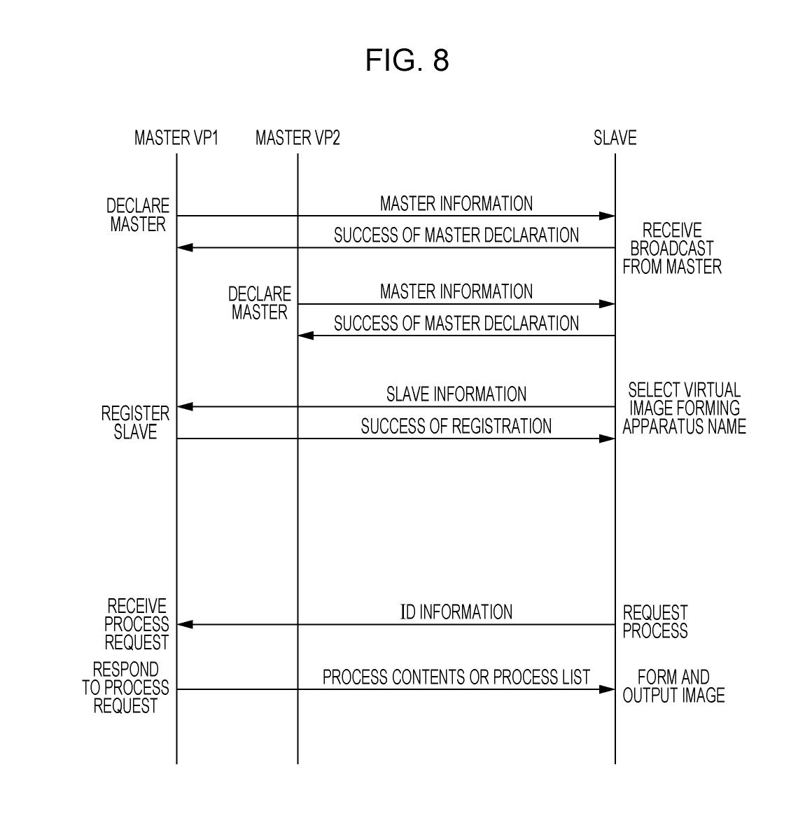

For example, if there are two selected masters, each of the image forming apparatus 12 serving as a master VR1 and the image forming apparatus 12 serving as a master VR2 displays the names of constructible virtual image forming apparatuses on the user interface 22 of the master to prompt the user to select a virtual image forming apparatus name. As the master information, the selected virtual image forming apparatus name and the identification information, such as the IP address, of the master are thereby transmitted by broadcasting to the image forming apparatus 12 that may serve as the slave, as illustrated in FIG. 8. Thereby, the master declaration is made.

Meanwhile, the slave image forming apparatus 12 displays the virtual image forming apparatus names by using the result received from the master to prompt the user to select a virtual image forming apparatus name, and transmits the slave information including the identification information, such as the IP address, of the slave to the master VR1 of the selected virtual image forming apparatus. Thereby, the slave information is registered in the master image forming apparatus 12. Further, after the slave registration succeeds, the master notifies the slave of the success of the slave registration. Thereby, the virtual image forming apparatus is constructed.

Further, after the virtual image forming apparatus is constructed, the information processing apparatus 14 transmits to the virtual image forming apparatus the image formation request including information related to the virtual image forming apparatus name. Thereby, the image formation request including the image information is stored in the master image forming apparatus 12. For example, if the virtual image forming apparatus name is included in the image formation request received from the information processing apparatus 14 by the master image forming apparatus 12, the image formation request is stored as the image formation request corresponding to this virtual image forming apparatus name. Further, if the virtual image forming apparatus name is included in the image formation request received from the information processing apparatus 14 by the slave image forming apparatus 12, the received image formation request is transferred to and stored in the master image forming apparatus 12 corresponding to this virtual image forming apparatus name. Then, the user allows the ID card reader 44 of the slave image forming apparatus 12 of the virtual image forming apparatus to read the ID information of the user. Thereby, the ID information is transmitted to the master, and the master image forming apparatus 12 corresponding to the ID information transmits process contents or a process list, for example, to the slave. The slave image forming apparatus 12 thereby performs image formation in accordance with the image formation request including the image information and stored in the master.

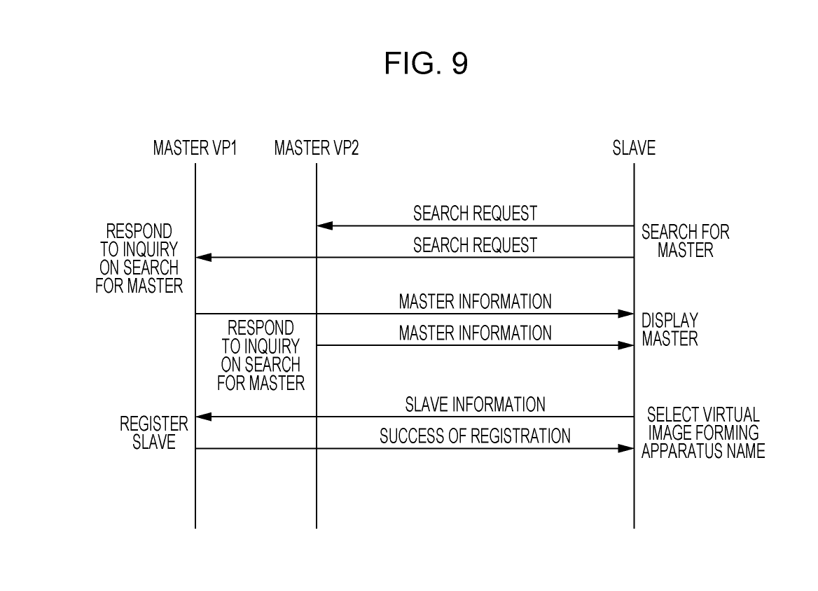

In the foregoing exemplary embodiment, the master information such as the identification information is transmitted from the master image forming apparatus 12 to the slave image forming apparatus 12 by broadcasting in the master declaration. The master information, however, may be transmitted at a different time. For example, as illustrated in FIG. 9, in the slave registration to the master, the slave image forming apparatus 12 may search for the image forming apparatus 12 declared as the master by broadcasting. Further, at the time of this search, the image forming apparatus 12 declared as the master may transmit the master information to the slave image forming apparatus 12 that has transmitted a search request. This configuration also makes the construction of the virtual image forming apparatus easy.

Further, the processes performed by the image forming apparatuses 12 according to the foregoing exemplary embodiment may be performed by software, hardware, or the combination of software and hardware. Further, the processes performed by the image forming apparatuses 12 may be distributed as stored in a storage medium as a program.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art, and the present invention may be implemented in various forms within a scope not deviating from the gist of the invention. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus forming a virtual image forming apparatus including a plurality of mutually communicably connected image forming apparatuses including at least one functional image forming apparatus having a storage function of storing an image formation request including image information and serving as a master and at least one image forming apparatus serving as a slave, the image forming apparatus comprising:
a transmitting unit that transmits master information and first identification information to the at least one image forming apparatus serving as the slave, the master information indicating that the at least one functional image forming apparatus is the master, and the first identification information identifying the master; and
a receiving unit that receives second identification information that identifies the at least one image forming apparatus serving as the slave.

2. The image forming apparatus according to claim 1 further comprising:
a display that displays the virtual image forming apparatus when the virtual image forming apparatus is constructible; and
a selecting unit that selects the virtual image forming apparatus displayed on the display,
wherein the transmitting unit transmits, by broadcasting, the master information and the first identification information of the virtual image forming apparatus selected by the selecting unit to the at least one image forming apparatus serving as the slave.

3. The image forming apparatus according to claim 1, wherein, in accordance with a request from the at least one image forming apparatus serving as the slave, the transmitting unit transmits the master information and the first identification information to the at least one image forming apparatus serving as the slave and a source of the request.

4. An image forming apparatus forming a virtual image forming apparatus including a plurality of mutually communicably connected image forming apparatuses including at least one functional image forming apparatus having a storage function of staring an image formation request including image information and serving as a master and at least one image forming apparatus serving as a slave, the image forming apparatus comprising:
an apparatus display that displays, by using master information and first identification information received from the master, the virtual image forming apparatus with the master declared, the master information indicating that the at least one functional image forming apparatus is the master, and the first identification information identifying the master;
an apparatus selecting unit that selects the virtual image forming apparatus displayed on the apparatus display; and
an information transmitting unit that transmits second identification information to the master of the virtual image forming apparatus selected by the apparatus selecting unit, the second identification information identifying the at least one image forming apparatus serving as the slave.

5. The image forming apparatus according to claim 4, wherein the apparatus display displays, by using the master information and the first identification information previously transmitted from the master by broadcasting, the virtual image forming apparatus with the master declared, and
wherein the information transmitting unit transmits the second identification information by using the master information and the first identification information.

6. The image forming apparatus according to claim 4, wherein the apparatus display displays, by using the master information and the first identification information acquired in response to a request broadcast to acquire the master information and the first identification information, the virtual image forming apparatus with the master declared, and
wherein the information transmitting unit transmits the second identification information by using the master information and the first identification information.

7. An image forming system that constructs a virtual image forming apparatus including a plurality of mutually communicably connected image forming apparatuses including at least one functional image forming apparatus having a storage function of storing an image formation request including image information and serving as a master image forming apparatus and at least one image forming apparatus serving as a slave image forming apparatus, the image forming system comprising:
the master image forming apparatus including
a transmitting unit that transmits master information and first identification information to the slave image forming apparatus, the master information indicating that the at least one functional image forming apparatus is the master image forming apparatus, and the first identification information identifying the master image forming apparatus, and
a receiving unit that receives second identification information that identifies the slave image forming apparatus; and
the slave image forming apparatus including
an apparatus display that displays, by using the master information and the first identification information received from the master image forming apparatus of the virtual image forming apparatus, the virtual image forming apparatus with the master image forming apparatus declared,
an apparatus selecting unit that selects the virtual image forming apparatus displayed on the apparatus display, and
an information transmitting unit that transmits the second identification information to the master image forming apparatus of the virtual image forming apparatus selected by the apparatus selecting unit.
